(19) United States
(12) Patent Application Publication
(10) Pub. No.: US 2018/0233111 A1
(43) Pub. Date: Aug. 16, 2018

(54) CONTROL GATEWAY BETWEEN AN AVIONICS COMPONENT AND A MOBILE DEVICE

(71) Applicant: Airbus Operations (S.A.S.), Toulouse (FR)

(72) Inventors: Bertrand Leconte, TOULOUSE (FR); Sylvie Delprat, Pibrac (FR); Eric Bonnefon, Vacquiers (FR); Guillaume Petit, Tournefeuille (FR); Sandy Duchesne, Saint Jean (FR)

(21) Appl. No.: 15/885,343

(22) Filed: Jan. 31, 2018

(30) Foreign Application Priority Data
Feb. 13, 2017 (FR) 1751155

(51) Int. Cl. G09G 5/12; G07C 5/00; G06F 3/0483; G06F 3/0489; G06F 3/14

(52) U.S. Cl. CPC G09G 5/12; G07C 5/008; G06F 3/0483; G09G 2380/12; G06F 3/1454; G09G 2354/00; G06F 3/04897

(57) ABSTRACT

A control gateway to control synchronization of display between an avionics component and a mobile device, the gateway being configured, on the one hand, to control any current avionics page from the avionics component before transmitting the controlled page, called validated current page, to the mobile device for it to be displayed thereon and, on the other hand, to control, on the basis of the validated current page, any key command from the mobile device before transmitting or not transmitting the key command to the avionics component.

### CROSS-REFERENCE TO RELATED APPLICATION

This patent application claims priority to French patent application FR 17 51155, filed on Feb. 13, 2017, the entire disclosure of which is incorporated by reference herein.

### TECHNICAL FIELD

The present disclosure relates to the field of servicing or maintenance on an aircraft and, more particularly, remote access to an avionics component of the cockpit to perform maintenance operations.

### BACKGROUND

Generally, an aircraft comprises a centralized monitoring system intended to store data relating to alerts or failures detected on the aircraft, as well as information from avionics systems of the aircraft. This centralized system is linked to one or more avionics component(s) installed in the cockpit of the aircraft. Each avionics component usually comprises a human-machine interface comprising a screen and command buttons and whose configuration depends generally on the type or options of the aircraft.

During servicing or when carrying out maintenance tasks on an aircraft on the ground, the maintenance operator needs to access the cockpit to consult pages on the screen of the avionics component and, for example, to manipulate buttons activating mechanisms which may be located outside the aircraft. This servicing may require several round trips between the cockpit and the outside of the aircraft and/or cooperation between an operator who remains in the cockpit and another outside the aircraft. All these intrusions into the cockpit can hamper the pilots and extend the servicing time. Furthermore, they require the availability of cockpit equipment items (screens, buttons, etc.) for the maintenance operator.

An object of the present disclosure is consequently to simplify the maintenance operations on the aircraft without hindering the pilots while reducing the servicing time or the number of operatives.

### SUMMARY

The present disclosure relates to a control gateway intended to control synchronization of display between an avionics component and a mobile device, the gateway being configured, on the one hand, to control any current avionics page from the avionics component before transmitting the controlled page, called validated current page, to the mobile device for it to be displayed thereon and, on the other hand, to control, on the basis of the validated current page, any key command from the mobile device before transmitting or not transmitting the key command to the avionics component.

This makes it possible to access the interface of the avionics component remotely on the mobile device by securing and by adapting the synchronization of display between the avionics component and the mobile device. In effect, in the prior art, the equipment items and screens of the cockpit of an aircraft cannot be accessed from outside the cockpit. Thus, the present disclosure allows the operator to have more mobility to perform the maintenance operations totally securely without hindering the pilots, while minimizing the servicing time.

### BRIEF DESCRIPTION OF THE DRAWINGS

Other features and advantages of the system and of the method according to the disclosure herein will become more apparent on reading the following description, given in an indicative but non-limiting way, with reference to the attached, example drawings in which:

FIG. 1 schematically illustrates a control gateway intended to control synchronization of display between an avionics component and a mobile device, according to an embodiment of the disclosure herein;

FIG. 2 schematically illustrates a control gateway, according to a preferred embodiment of the disclosure herein;

FIG. 3 illustrates an example of an interface of the avionics component;

FIG. 4 schematically illustrates an example of a page defined in the tree structure of the state machine, according to an embodiment of the disclosure herein;

FIG. 5 schematically illustrates a method implementing control of synchronization of display between an avionics component and a mobile device, according to an embodiment of the disclosure herein;

FIGS. 6A-6D schematically illustrate different scenarios for controlling a current avionics page, according to an embodiment of the disclosure herein; and

FIG. 7 schematically illustrates an avionics element comprising the control gateway, according to an embodiment of the disclosure herein.

### DETAILED DESCRIPTION

A principle of the disclosure herein concerns synchronizing a mobile device securely with an avionics component of the aircraft.

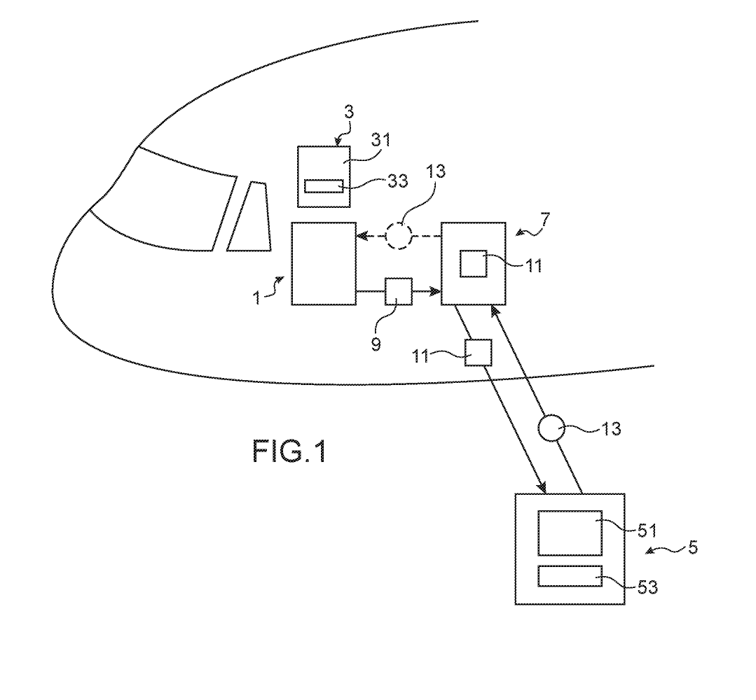

FIG. 1 schematically illustrates a control gateway intended to control a synchronization of display between an avionics component and a mobile device, according to an embodiment of the disclosure herein.

Generally, an aircraft comprises a centralized monitoring system intended to store data relating to alerts, failures or anomalies detected on the aircraft during the different flights, as well as information from the avionics systems. This centralized monitoring system is linked to one or more equipment item(s) installed in the cockpit of the aircraft and intended for maintenance or for other avionics functions. Herein below, the avionics component refers by way of example to a maintenance avionics system installed in the cockpit.

The avionics component 1 comprises a human-machine interface 3 comprising a screen 31 and a keyboard and/or command buttons 33. The screen 31 is intended to display pages containing information on the functions or commands of the different command buttons 33 as well as information useful for maintenance or for other servicing operations.

The mobile device 5 is a laptop computer or a tablet usually comprising a screen 51 and a physical or virtual keyboard comprising command keys 53. In accordance with the disclosure herein, the control gateway 7 is intended to control a two-way transfer of data between the avionics component 1 and the mobile device 5. More particularly, in the direction of data transfer from the avionics component 1 to the mobile device 5, the control gateway 7 is configured to control or filter any current avionics page 9 from the avionics component 1. The current avionics page 9, once controlled or filtered, is herein below called validated current page 11. The latter is then transmitted to the mobile device 5 for it to be displayed on the screen 51 thereof. It will be noted that the validated current page 11 can be identical to the current avionics page 9 or different therefrom according to predetermined rules. For example, for security reasons, certain command keys may not be authorized from outside the cockpit.

In the opposite direction of data transfer (i.e. from the mobile device 5 to the avionics component 1), the control gateway 7 is configured to control, on the basis of the validated current page 11, any key command 13 from the mobile device 5 before transmitting or not transmitting the key command 13 to the avionics component 1. In effect, if a command key is defined in the validated current page 11 as being not authorized, then the command from this key is not transmitted to the avionics component 1 even if the operator has pressed on this key.

It will be noted that the mobile device 5 comprises a standard transmission-reception application allowing it to receive pages and transmit key commands.

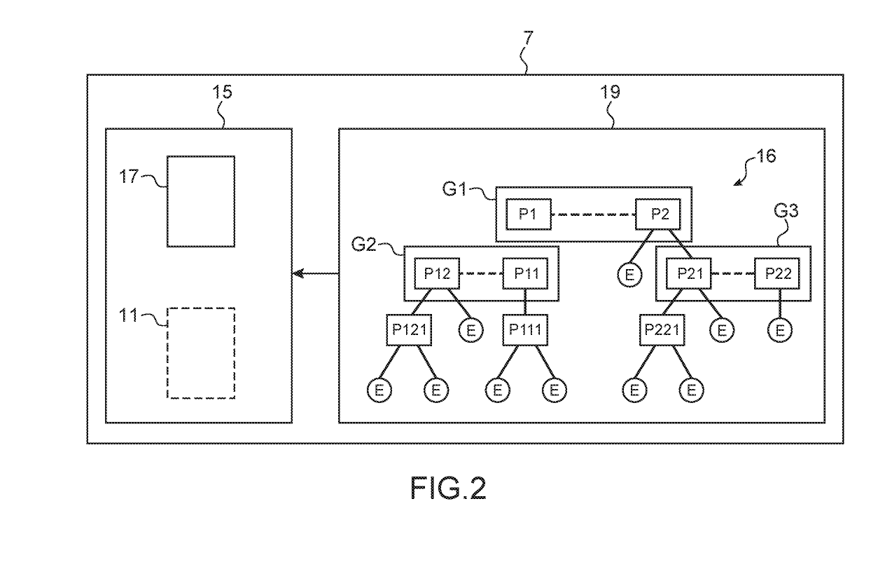

FIG. 2 schematically illustrates a control gateway, according to a preferred embodiment of the disclosure herein.

The control gateway 7 advantageously comprises a state machine 15 configured to be in a current state out of a predetermined set of states and organized according to a state chart or tree structure 16. The state machine 15 is further configured to modify its current state as a function of the current avionics page 9 from the avionics component 1 and of the key command 13 from the mobile device 5.

As an example, the predetermined set of states is organized according to a tree structure 16 comprising a root, internal nodes and leaves. The example of FIG. 2 illustrates a start up tree structure 16 comprising a root associated with a main group G1 comprising two pages P1 and P2. The internal nodes are here organized according to two levels. The first level is associated with first and second secondary groups G2 and G3 comprising the pages P11, P12 and P21, P22 respectively. The second level is associated with unitary pages P111, P121 and P221. Finally, the leaves correspond to final actions or final tests E indicating the end of the tree structure. The current state of the state machine is hereinafter called “current expected page” 17. The command keys generate either new menus (i.e. new pages) or end-of-action pages. Thus, on each branch of the tree structure, the menus are sequenced until an end-of-action page is reached.

It will be noted that the pages belonging to one and the same group can represent pages that are equivalent but representative of different types of avionics components. For example, when a current avionics page can correspond to several pages of one and the same group, the control gateway 7 tests the different pages in the same group to search for which is best matched to the current avionics page 9.

Moreover, the example of FIG. 2 shows that the pages P1 and P2 of the main group G1 are linked to the first G2 and second G3 secondary groups respectively. The second page P2 is further linked to a final action. The first page P11 of the first secondary group G2 is linked to a single page P111 which, in turn, is linked to two final actions. The second page P12 of the first secondary group G2 is linked on the one hand to a final action and on the other hand to a single page P121 which, in turn, is linked to two final actions. The first page P21 of the second secondary group G3 is linked on the one hand to a final action and on the other hand to a single page P221 which, in turn, is linked to two final actions. The second page P22 of the second secondary group G3 is linked only to a final action.

The links between the different nodes of the tree structure 16 are activated by the command keys 53 of the mobile device 5. In effect, the navigation of the state machine 15 from page to page in the tree structure 16 is driven by the command of a key from the mobile device 5. The state machine 15 comprises, for example, a pointer which changes position as a function of the command form the mobile device 5. Moreover, the movement from page to page within one and the same group of pages of the tree structure 16 results from the search, by the control gateway 7, for the page best matched to the current avionics page 9 from the avionics component 1.

The tree structure 16 is defined in a configuration file 19 intended to parameterize the state machine 15. Advantageously, this configuration file 19 generically comprises all the possible pages and actions of all the options or versions of the avionics component 1.

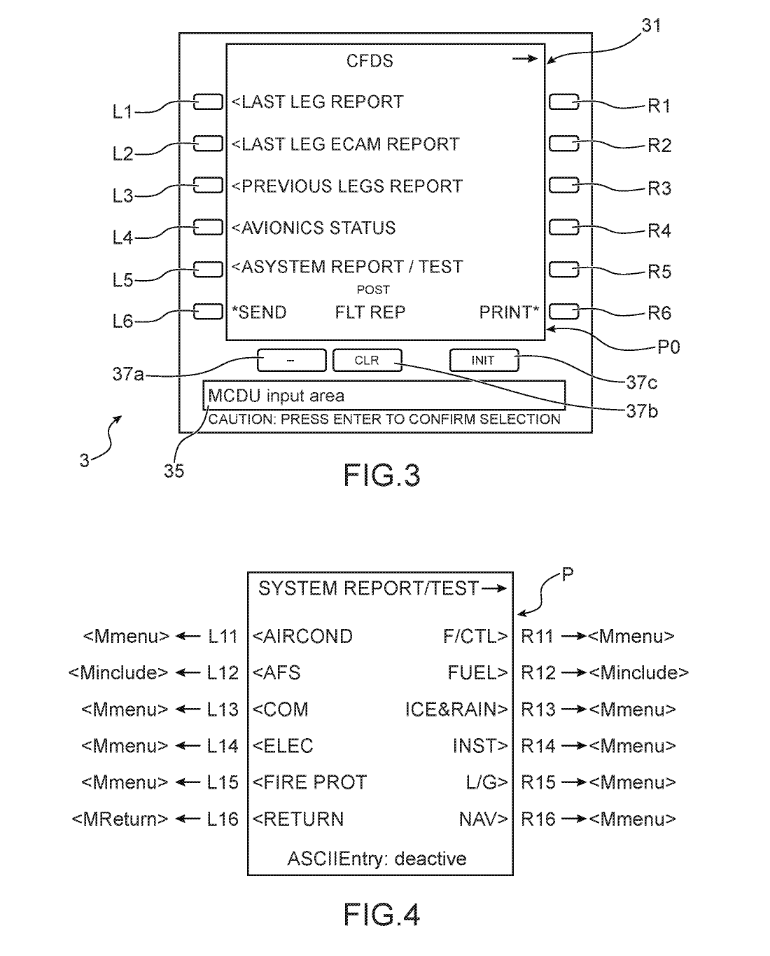

FIG. 3 illustrates an example of an interface of the avionics component. This avionics interface 3 comprises an avionics screen 31 and six command buttons L1 to L6 on the left of the screen 31 and six command buttons R1 to R6 on the right of the screen 31. The avionics screen 31 displays an avionics page comprising a title as well as a set of texts or command labels indicating the functions or commands of the different buttons L1-L6 and R1-R6. Furthermore, the avionics interface 3 comprises, below the screen 31, an input zone 35 as well as three other buttons 37a-37c intended to actuate the transition to a next page, to delete the last character entered and to initialize the screen 31. It will be noted that the current page displayed on the avionics screen 31 represents the current avionics page sent to the control gateway 7. The example of the avionics page represented on FIG. 3 corresponds to an initialization page PO on starting up the avionics component 1.

FIG. 4 schematically illustrates an example of a page defined in the tree structure of the state machine, according to an embodiment of the disclosure herein.

The page P defined in the state machine 15 comprises a text or labels designating six command keys L11 to L16 on the left of the page P and six command keys R11 to R16 on the right of the page P. Moreover, the page P also comprises a title and an arrow signifying that there is a next page in the same group.

The control gateway 7 is configured to compare the command key labels L11-L16 and R11-R16 of the current expected page of the state machine to the corresponding command labels L1-L6 and R1-R6 of the current avionics page as well as, possibly, the respective titles of the two pages.

It will be noted that, in particular embodiments, the state machine can further test information texts which can be arranged between the labels of the keys or between the lines of the labels of the keys or anywhere on the screen, when the page includes such texts.

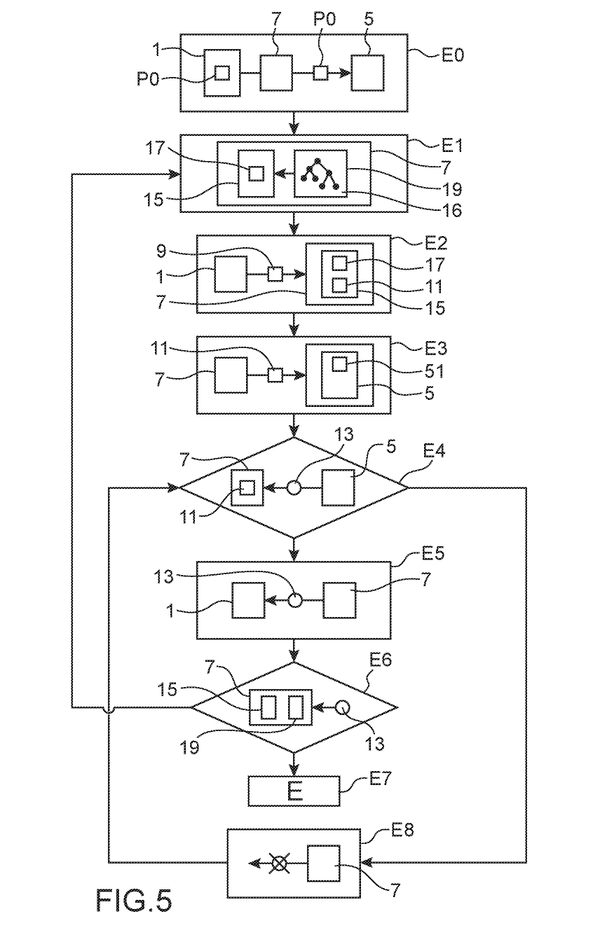

FIG. 5 schematically illustrates a method implementing a control of synchronization of display between an avionics component and a mobile device, according to an embodiment of the disclosure herein.

The step E0 is an initialization step in which the control gateway 7 transmits to the mobile device 5 an initialization avionics page PO (see FIG. 3) from the avionics component 1. In effect, as soon as the avionics component 1 is switched on, a default initialization page is displayed.

In the step E1, the state machine 15 assumes a position in the tree structure 16 corresponding to a current expected page 17.

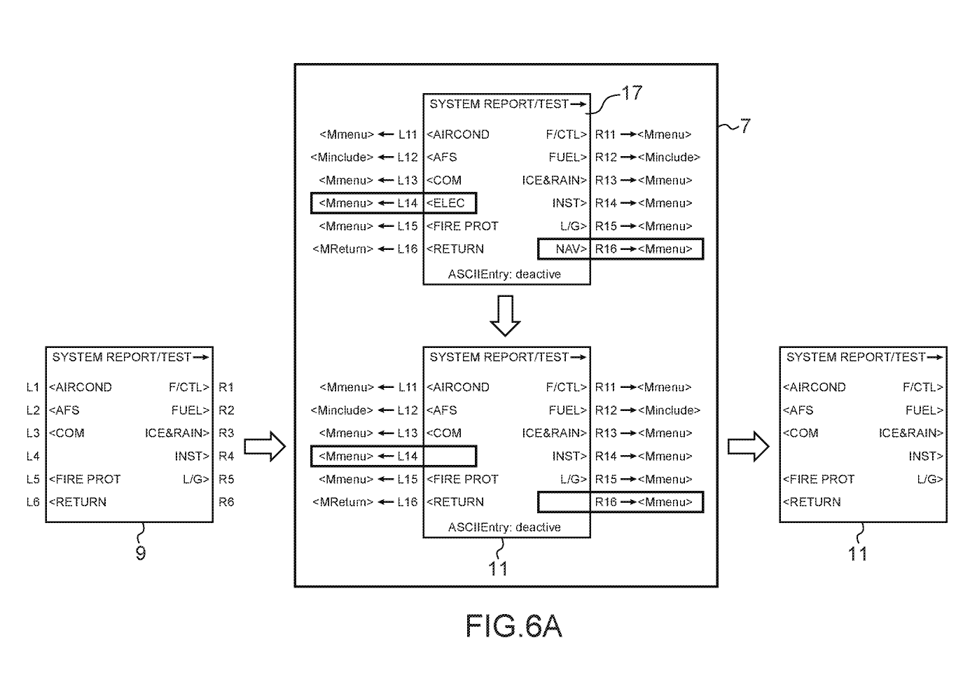

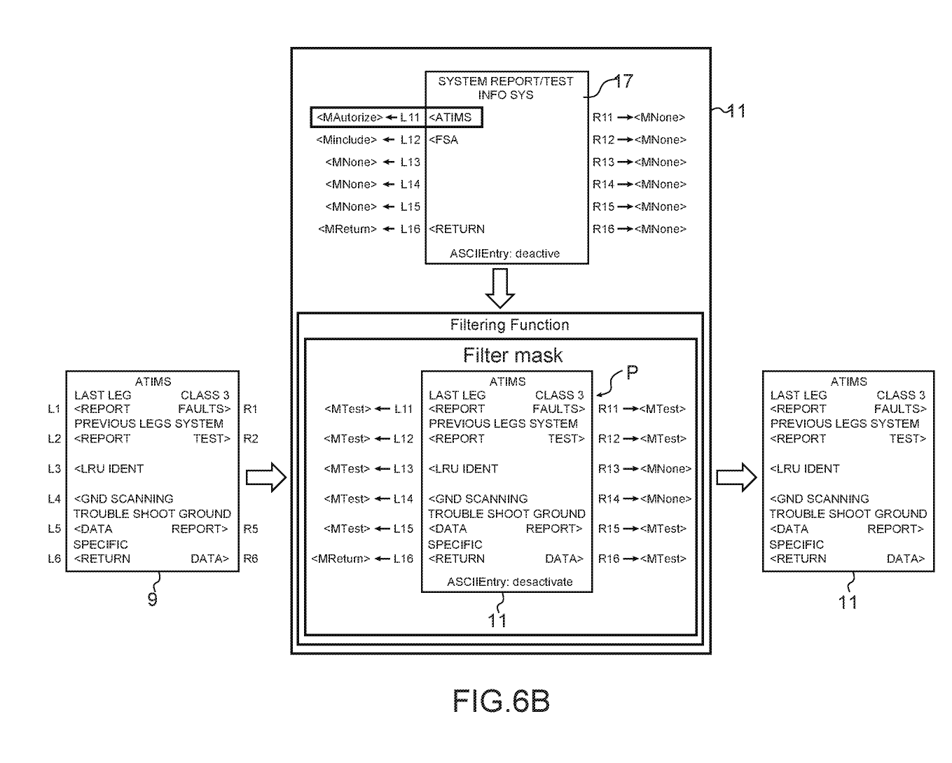

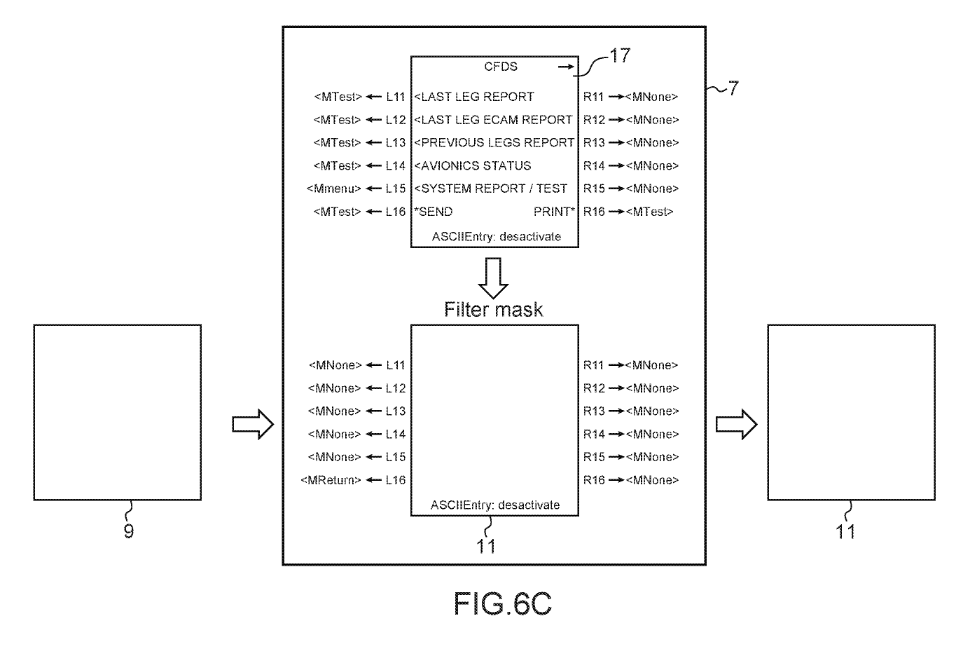

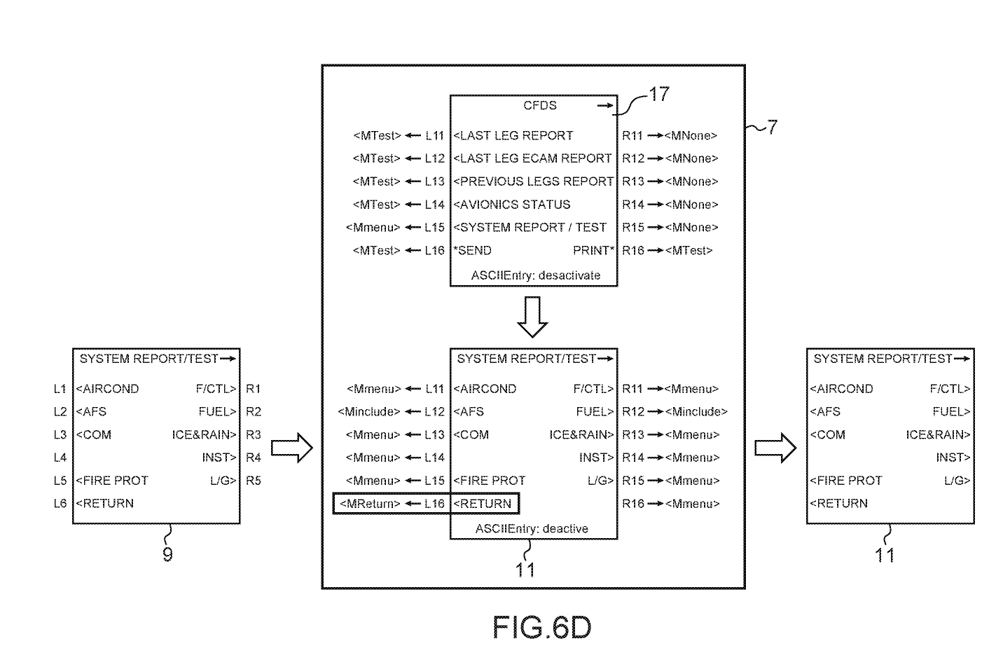

In the step E2, the control gateway 7 is configured to control a current avionics page 9 from the avionics component 1. More particularly, the control gateway is configured to compare the current avionics page 9 with the current expected page 17 of the state machine 15. The control gateway 7 forms the validated current page 11 on the basis of this comparison and according to predetermined rules (see FIGS. 6A-6D). For example, the validated current page 11 can indicate command keys not authorized for the operator of the mobile device 5.

In the step E3, the control gateway 7 is configured to transmit the validated current page 11 to the mobile device 5 for it to be displayed on the screen 51 thereof.

In the step E4, the control gateway 7 is configured to control any key command from the mobile device 5. More particularly, the step E4 is a test in which the control gateway 7 checks whether a key command 13 received from the mobile device 5 conforms to the validated current page 11 which has been transmitted to it. If it does, the procedure goes onto the step E5 and, if it does not, the procedure goes onto the step E8.

In the step E5, the control gateway 7 is configured to transmit the current key command 13 to the avionics component 1 because it has been verified (in the step E4) as conforming to the validated current page 11.

The step E6 is another test in which the control gateway 7 checks whether the current key command 13 received from the mobile device 5 drives the state machine 15 to a menu sub-page (i.e. a new page) or to a final action page. If the current key command drives to a new page, then the procedure loops to the step El in which the state machine 15 is driven to another current state corresponding to a new current expected page or, in certain cases (see FIG. 6B), the state machine 15 remains on the same page. Otherwise, that is to say if the current key command 13 leads to a final action page, then there is a transition to the end-of-method state E7.

The step E8 corresponds to the case where the key command 13 has been verified in the step E4 as not conforming to the validated current page 11. Then, the control gateway 7 does not transmit the current key command 13 to the avionics component 1 and the current state of the state machine 15 remains unchanged. In this case, the procedure loops to the step E4 in which the control gateway 7 awaits another key command from the mobile device 5.

The control gateway 7 thus makes it possible to filter certain information in the current avionics page 9 before transmitting it to the mobile device 5. It also makes it possible to block command keys as a function of the current avionics page 9 in order to bar certain actions to the users of the mobile device 5.

FIGS. 6A-6D schematically illustrate different scenarios for controlling a current avionics page, according to an embodiment of the disclosure herein.

The control is based on a mechanism of comparison of the current avionics page 9 with the expected page 17 by the state machine 15. This mechanism makes it possible to authorize or block a key command 13 from the mobile device 5 and to modify the current avionics page 9 by forming a validated current page 11 indicating the keys that are blocked. Thus, it is the control gateway 7 which associates or does not associate a function with each command key.

FIG. 6A illustrates the filtering of a current avionics page 9 relative to a corresponding expected page 17. More particularly, the control gateway 7 compares the labels of the command buttons defined in the current avionics page 9 to the expected command key labels defined in the current expected page 17 of the state machine. Any expected command key label not having a corresponding label in the current avionics page 9 is not represented on the validated current page 11. On the other hand, any expected command key label having a corresponding label in the current avionics page 9 is represented on the validated current page.

The example of FIG. 6A shows that the current avionics page 9 comprises labels of the command buttons corresponding to the labels of all the command keys except for L4 and R6. In effect, only the current expected keys L14 and R16 (framed) do not have corresponding elements in the current avionics page 9. Thus, the validated current page 11 transmitted to the mobile device 5 is formed without labels for the keys L14 and R16 which are considered as non-actuatable. The keys that are not authorized are indicated in the state machine by the text “MNone”.

FIG. 6B illustrates the authorization by the control gateway 7 of a page belonging to a sub-branch of the tree structure.

Certain levels or branches of the tree structure 16 are considered by the control gateway 7 as entirely authorized and do not pose any security problems. In this case, the control gateway 7 checks only the title of the current avionics page 9.

Thus, the control gateway 7 transmits to the mobile device 5 a validated current page 11 identical to the current avionics page 9 in the case where, on the one hand, the current expected page 17 belongs to an authorized sub-branch of the tree structure 16 and, on the other hand, the title of the current avionics page 9 conforms to a title expected (framed) by the current expected page 17.

In effect, when the control gateway 7 receives a key command from the mobile device 5 which corresponds to an authorized sub-branch then the control gateway 7 transmits this key command to the avionics component 1 and the state engine 15 remains in the same state. Here, the operator had to press on the key L11 labelled “ATIMS” which indicates the label “MAuthorize” representative of a transition to an authorized sub-branch. The current expected page 17 of the state machine 15 still remains on the page which was sent previously to the mobile device 5. In response to the command key, the avionics component 1 transmits to the control gateway 7 a new page corresponding to this command. In this case, the control gateway 7 quite simply compares the title (here ATIMS) of the current avionics page 9 to the title expected (here ATIMS) by the current expected page 17. Then, since the titles match, the gateway 7 transmits the current avionics page 9 unchanged to the mobile device 5. In other words, the current validated page 11 is here identical to the current avionics page 9.

FIG. 6C illustrates the transfer of a transition page from the avionics component 1 to the mobile device 5. A transition page is a page which contains no command labels. In other words, a transition page can be either a blank page or a page including a text unrelated to command buttons.

Thus, in the case where the current avionics page 9 is a transition page not containing any command label, the control gateway 7 is configured to transmit to the mobile device 5 a validated current page 11 identical to the current avionics page 9. This makes it possible to have a perfect synchronization between the display on the screen of the avionics component and on that of the mobile device.

FIG. 6D illustrates the blocking by the control gateway of a current avionics page not conforming to the current expected page. In effect, in the case where the current avionics page 9 is different from the current expected page 17, the control gateway 7 is configured to transmit to the mobile device 5 a validated current page 11 in which all the command key labels indicate that the command keys are not authorized except for the return command key (framed) which makes it possible to go back to the preceding page. The label of a key that is not authorized is indicated for example by a change of symbol. Here, the chevrons are replaced by a number sign visually indicating to the user that the key is not accessible.

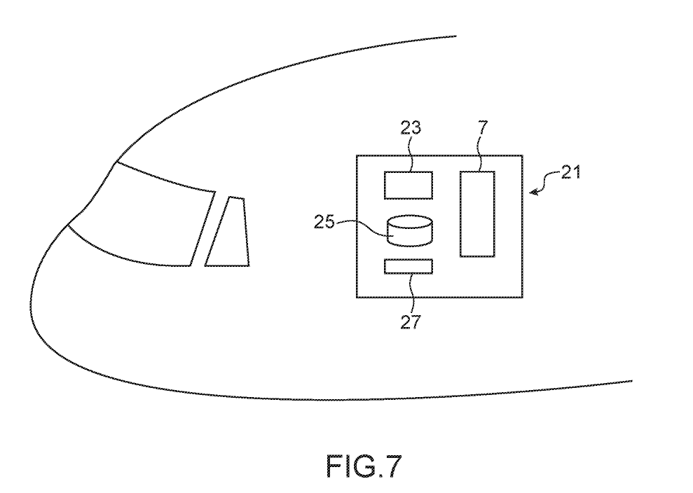

FIG. 7 schematically illustrates an avionics element comprising the control gateway, according to an embodiment of the disclosure herein.

The avionics element 21 is a system comprising a processor 23, memories 25 and transmission-reception modules 27. Advantageously, the control gateway 7 is implemented by one or more application(s) implemented by the avionics element. The applications and the tree structure configuration files are stored in the memories 25 of the avionics element 21. Thus, the avionics element 21 is adapted to securely ensure the exchange of data between, on the one hand, one or more avionics components 1 and, on the other hand, one or more mobile devices 5.

As a variant, the control gateway 7 can be implemented in the avionics component 1 itself.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A control gateway to control a synchronization of display between an avionics component and a mobile device, the gateway being configured to control any current avionics page from the avionics component before transmitting the controlled page, called validated current page, to the mobile device for it to be displayed thereon, and the gateway being configured to control, on a basis of the validated current page, any key command from the mobile device before transmitting or not transmitting the key command to the avionics components, the gateway comprising a state machine configured to be in a current state out of a predetermined set of states, the state machine being further configured to modify its current state as a function of the current avionics page from the avionics component and of the key command from the mobile device, the current state of the state machine being called current expected page, the gateway being further configured to compare the current avionics page from the avionics component with the current expected page of the state machine and to form the validated current page on a basis of this comparison, the validated current page being able to be similar to or different from the current avionics page.

2. The control gateway according to claim 1, wherein the predetermined set of states is organized according to a tree structure comprising a root, internal nodes and leaves, the root corresponding to at least one main group of pages, the internal nodes corresponding to secondary groups of pages, and the leaves corresponding to final actions.

3. The control gateway according to claim 1, wherein the control gateway is configured to compare a set of command button labels defined in the current avionics page to a set of expected command key labels defined in the current expected page, any expected command key label not having a corresponding label in the current avionics page not being represented on the validated current page while any expected command key label having a corresponding label in the current avionics page is represented on the validated current page.

4. The control gateway according to claim 1, wherein the control gateway is configured to transmit to the mobile device a validated current page identical to the current avionics page in the case where, the current expected page belongs to an authorized sub-branch of the tree structure, and a title of the current avionics page conforms to a title expected by the current expected page.

5. The control gateway according to claim 1, wherein the control gateway is configured to transmit to the mobile device a validated current page identical to the current avionics page in a case where the current avionics page is a transition page not comprising any command label.

6. The control gateway according to claim 1, wherein, in a case where the current avionics page is different from the current expected page, the control gateway is configured to transmit to the mobile device a validated current page in which all the command key labels indicate that the command keys are not authorized except for the return command key.

7. The control gateway according to claim 1, wherein the control gateway is configured to transmit the current key command to the avionics component if it conforms to the validated current page and to not transmit the current key command if it does not conform to the validated current page.

8. An avionics element comprising a control gateway according to claim 1.
